(19) United States
(12) Patent Application Publication
(10) Pub. No.: US 2002/0097778 A1
(43) Pub. Date: Jul. 25, 2002

(54) Thermo-sensitive labels for beverage containers

(76) Inventors: Jason Moroskat, Edmonton (CA); Todd Druar, Spruce Grove (CA)

Correspondence Address: Todd M Druar, Jason Moroskat, 14412 - 97 Avenue, Edmonton, AB, T5N0E2, CA

(21) Appl. No.: 09/767,674

(22) Filed: Jan. 22, 2001

(51) Int. Cl. G01K 13/00; G01K 1/14; G01K 11/12

(52) U.S. Cl. 374/162; 374/150; 116/216

(57) ABSTRACT

A thermo-sensitive label construction (10) adapted to be adhesively secured to a conventional beverage container (100) wherein the label construction (10) includes a label member (20) having a front face (21) provided with two distinct types of visual indicators (30) and (40) wherein the first visual indicator (30) is an enlarged contoured area (31) having the silhouette of a beverage container and provided with one or more thermo-sensitive coatings (50) and the second type of visual indicator (40) includes printed legends in the form of a cautionary admonishment (41) and a salutation (42) which correspond in color to the respective thermo-sensitive coatings (50).

### BACKGROUND OF THE INVENTION

1. Field of the Invention

The present invention relates to the field of temperature indicating devices in general and in particular to a thermo-sensitive label that can be adhered to a beverage container to provide a visual indication of the temperature of the beverage within the container.

2. Description of Related Art

As can be seen by reference to the following U.S. Pat. Nos. 5,482,373; 5,008,136; 4,538,926; 4,038,873; and, 6,030,118, the prior art is replete with myriad and diverse temperature indicating devices including labels that can be affixed to beverage containers.

While all of the aforementioned prior art constructions are more than adequate for the basic purpose and function for which they have been specifically designed, they are uniformly deficient with respect to their failure to provide a simple, efficient, aesthetically appealing and unique thermo-sensitive label for beverage containers that will both entertain and amuse your guests.

While the acknowledged prior art devices certainly provide visual indicators relating to the temperature of the liquid within the beverage containers, their approach to date has been fairly straightforward, conventional and somewhat dull from the standpoint of providing any entertainment value for the users thereof.

As a consequence of the foregoing situation, there has existed a longstanding need among individuals who enjoy entertaining their friends for a new and improved type of thermo-sensitive label for beverage containers; wherein, the label is specifically designed to incorporate an uplifting message that will become visible once the beverage container has been chilled to the proper degree; and, the provision of such a construction is the stated objective of the present invention.

### BRIEF SUMMARY OF THE INVENTION

Briefly stated, the thermo-sensitive label for beverage containers that forms the basis of the present invention comprises in general a label member having a conventional adhesive backing formed on its rear face and a front face that is treated with different thermo-sensitive chemical compounds that are arranged in a specific pattern to produce an aesthetically pleasing appearance as well as an unexpected and amusing visual effect.

As will be explained in greater detail further on in the specification, the front face of the label member is provided with two distinct types of visual indicia wherein the first type of visual indicia resembles the configuration of a beverage container and the second type of indicia constitutes descriptive words that appear and disappear as the liquid contents of the container become chilled.

In one version of the preferred embodiment, the descriptive words include both a cautionary warning and a salutation; wherein, the cautionary warning is visible as long as the temperature of the beverage container is above a certain value; and, wherein the salutation becomes visible only when the temperature of the beverage container falls below a certain value.

This feature is particularly valuable during large social gatherings wherein a communal cooler is used to chill down beverage containers and relatively warm containers contributed by late arrivals are mixed in with other containers that have spent sufficient time within the cooler to be chilled to the proper degree.

In addition, the cautionary warning and salutation indicia are not only clearly visible on the exterior of the respective beverage containers; but, also add a degree of levity and amusement for the people attending the social gathering that would not be possible with the indicia arrangements employed by the prior art arrangements.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view showing the thermo-sensitive label affixed to a conventional beverage container;

FIG. 2 is an enlarged front plan view of the preferred embodiment of the indicia arrangement after it has reached an optimum chilled state.

FIG. 3 is an enlarged front plan view of the preferred embodiment prior to being exposed to a chilled environment;

FIG. 4 is an enlarged front plan view of the alternate version of the preferred embodiment prior to being exposed to a chilled environment;

FIG. 5 is the same enlarged front plan as the FIG. 3 view showing the label after it has reached a semi-chilled state; and,

FIG. 6 shows the label appearance after the beverage container has obtained its optimum chilled state.

### DETAILED DESCRIPTION OF THE INVENTION

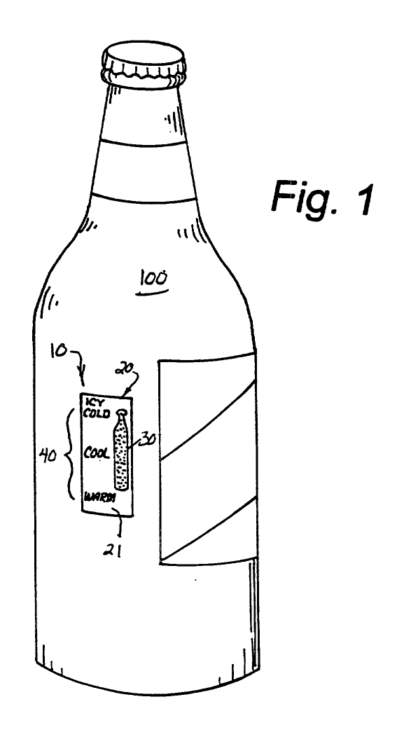

As can be seen by reference to the drawings, and in particular to FIG. 1, the thermo-sensitive label construction that forms the basis of the present invention is designated generally by the reference number 10. The construction (10) comprises in general a label member (20) having a front face ((21) provided with two distinct types of visual indicia designated generally as (30) and (40) wherein the label member (20) is further provided with a conventional adhesive backing (not shown) for affixing the label member (20) to the exterior surface of a conventional beverage container (100) such as a bottle or can in a well recognized fashion.

As an alternative, the construction 10 comprised of two distinct types of visual indicia designated generally as 30 and 40 can be directly printed to the exterior surface of a conventional beverage container.

In the preferred embodiment of the invention depicted in FIG. 3, the first type of visual indicia comprises an enlarged contoured area 31 in the shape of the silhouette of a conventional beverage container; wherein, the contoured area 31 is provided with a permanent ink 50′ which will represent the temperature of the beverage container 100 when it is above a certain temperature value. In FIG. 2, the contoured area 31 is provided with a layer of thermo-sensitive coating 50 such as leuco dye ink which is invisible when the temperature of the beverage container 100 is above a certain temperature value. The thermo-sensitive coating becomes visible one the beverage container 100 is chilled below a certain temperature value, and thus combines with the permanent layer of ink to produce a predetermined color. An example of this color change is: red permanent ink combined with a blue leuco dye ink produces an end result of purple.

As can also be seen by reference to FIGS. 2 and 3, the second type of visual indicia 40 comprises printed legends in the form of a cautionary admonishment 41 and a salutation 42. While FIGS. 2 and 3 show the cautionary admonishment as “not yet” and the salutation as “party time,” this invention also contemplates other cautionary admonishments 41 such as “time out,” “rain delay,” “red flag,” and the like coupled with other appropriate salutations 42 such as “play ball,” “resume play,” “green flag” and the like to customize the label construction 10 for different sports fans or marketing campaigns.

In the alternate version of the preferred embodiment depicted in FIGS. 4 through 6, the contoured area 31 is provided with layered thermo-sensitive coatings (50′″) (50″″) and also the base layer of permanent ink 50″ dispersed within the contoured area so that the dominant visible color within the enlarged contoured area will be representative of a given temperature of the beverage container 100.

This version described in FIGS. 4 through 6, works along the same principles as the preferred embodiment depicted in FIGS. 2 and 3. The alternate version has at least 2 layers of the thermochromic coatings dispersed within the contoured area 31 that allows this version to show multiple temperature values.

In this version of the preferred embodiment, the second type of visual indicia 40 comprises descriptive terminology 43 44 45 that describes different temperature conditions such as “warm,” “cool,” and “icy cold” that coincide with the relative temperature conditions within the beverage container 100.

Furthermore, these visual indicia 40 are printed in different colored inks that are always visible and correspond to the visible color of the various thermo-chromic coatings 50′″50″″ and also the base layer of permanent ink 50″.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

We claim:

1. A thermo-sensitive label construction for beverage containers wherein the label construction comprises:
an adhesive-backed label member having a front face provided with two types of visual indicia wherein the first type of visual indicia comprises an enlarged contoured area having the silhouette of a conventional beverage container wherein the enlarged contoured area is provided with at least one thermo-sensitive coating and a second type of visual indicia comprising printed legends.

2. The construction as in claim 1; wherein, the printed legends include a cautionary admonition and a salutation.

3. The construction as in claim 1; wherein, the two types of visual indicia which are printed to the front face of the label, can alternately be printed directly to the exterior surface of a conventional aluminum beverage container.

4. The construction as in claim 2; wherein, both the cautionary admonition and the salutation are sports related.

5. The construction as in claim 2; wherein the printed legends comprise descriptive terminology relating to different marketing campaigns.

6. The construction as in claim 2; wherein, the printed legends comprise descriptive terminology relating to temperature.

7. The construction as in claim 1; wherein, the enlarged contoured area is provided with one or more thermo-sensitive coatings and may or may not have a base coat of permanent ink.

8. The construction as in claim ; wherein, the cautionary admonition and the salutation are printed in different permanent inks whose color corresponds to the color produced by the respective thermo-sensitive coatings.

9. The construction as in claim 2; wherein, the printed legends are imprinted with at least one of the thermo-sensitive coatings.

10. The construction as in claim 10; wherein, the enlarged contoured area is provided with multiple thermo-sensitive coatings dispersed within the enlarged contoured area.

11. The construction as in claim 10; wherein, the printed legends comprise three different descriptive terms relating to the individual temperature ranges of the multiple thermo-sensitive coatings.

12. The construction as in claim 11; wherein, each of the three descriptive terms is imprinted with the thermo-sensitive coating having a temperature range that corresponds with a particular descriptive term.

13. The construction as in claim 12; wherein, each of the three descriptive terms is printed in different permanent inks whose color corresponds to the color produced by the respective thermo-sensitive coatings.
